(19) United States
(12) Patent Application Publication
(10) Pub. No.: US 2026/0012656 A1
(43) Pub. Date: Jan. 8, 2026

(54) Bit Stream Syntax For Partition Types

(71) Applicant: Google LLC, Mountain View, CA (US)

(72) Inventors: Cheng Chen, Milpitas, CA (US); Jingning Han, Sana Clara, CA (US)

(21) Appl. No.: 18/992,782

(22) PCT Filed: Jul. 19, 2023
(86) PCT No.: PCT/US2023/028187

§ 371 Date: Jan. 9, 2025

Related U.S. Application Data
(60) Provisional application No. 63/390,555, filed on Jul. 19, 2022.

(51) Int. Cl. H04N 19/91; H04N 19/119; H04N 19/176

(52) U.S. Cl. CPC H04N 19/91; H04N 19/119; H04N 19/176

(57) ABSTRACT

Complexity in entropy coding a partition type for a block in image and video coding is reduced by using a cardinality of symbols that is less than a cardinality of available partition types. A bitstream modification uses the block size, and optionally the location of the block relative to the frame boundaries, to select a probability table for entropy coding a variable representing the partition type. By allowing multiple variables to represent the partition types, instead of a single variable, multiple probability tables corresponding to the variables can be used that include fewer symbols.

### CROSS-REFERENCE TO RELATED APPLICATION

This application claims priority to U.S. Provisional Patent Application No. 63/390,555, filed Jul. 19, 2022, which is incorporated herein in its entirety by reference.

### BACKGROUND

Digital video streams may represent video using a sequence of frames or still images. Digital video can be used for various applications including, for example, video conferencing, high-definition video entertainment, video advertisements, or sharing of user-generated videos. A digital video stream can contain a large amount of data and consume a significant amount of computing or communication resources of a computing device for processing, transmission, or storage of the video data. Various approaches have been proposed to reduce the amount of data in video streams, including lossy and lossless compression techniques. Lossless compression techniques include entropy coding.

### SUMMARY

Probability estimation is used for entropy coding, particularly with context-based entropy coding for lossless compression. Efficiency of the entropy coding depends on the accuracy of the probability estimation. Entropy coding, particularly for hardware implementations, is relatively complex.

The teachings herein describe different methods and apparatuses for reducing the complexity of entropy coding partition types while maintaining the accuracy of the probability estimation. It does this by introducing a new bitstream syntax (also referred to as bit stream syntax) for partition types that allows a reduction in the number of symbols required for entropy coding.

According to an aspect of the teaching herein, a method of decoding a partition type for a block includes determining a block size of the block, selecting, based on the block size, a probability table for entropy coding a variable identifying the partition type, wherein the probability table is selected from multiple available probability tables, entropy coding the variable using a cardinality of symbols associated with the probability table, wherein the cardinality of symbols is less than a cardinality of available partition types, and determining the partition type using the variable.

According to an aspect of the teachings herein, a method of encoding a partition type for a block includes determining a block size of the block, determining a variable identifying the partition type, selecting, based on the block size, a probability table for entropy coding the variable identifying the partition type, wherein the probability table is selected from multiple available probability tables, and entropy coding the variable using a cardinality of symbols associated with the probability table, wherein the cardinality of symbols is less than a cardinality of available partition types.

In some implementations of these methods, selecting the probability table comprises selecting the probability table based on the block size and a position of the block relative to at least one boundary of an image containing the block.

In some implementations of these methods, selecting the probability table comprises selecting the probability table based on the block size and a position of the block relative to each of a vertical boundary and a horizontal boundary of an image containing the block.

An apparatus that can perform any of the methods is also described. The apparatus may be a hardware encoder or a hardware decoder in some implementations.

Aspects of this disclosure and variations thereof are disclosed in the following detailed description of the implementations, the appended claims, and the accompanying figures.

### BRIEF DESCRIPTION OF THE DRAWINGS

The description herein refers to the accompanying drawings described below, wherein like reference numerals refer to like parts throughout the several views.

FIG. 1 is a schematic of an example of a video encoding and decoding system.

FIG. 2 is a block diagram of an example of a computing device that can implement a transmitting station or a receiving station.

FIG. 3 is a diagram of an example of a video stream to be encoded and subsequently decoded.

FIG. 4 is a block diagram of an example of an encoder.

FIG. 5 is a block diagram of an example of a decoder.

FIG. 6A is a block diagram of an example of recursive partitioning of a block according to implementations of this disclosure.

FIG. 6B is a block diagram of an example of extended partition types of a block according to implementations of this disclosure.

FIG. 7 is a flowchart diagram of a technique of decoding a partition type for a block.

### DETAILED DESCRIPTION

Video compression schemes may include breaking respective images, or frames, into smaller portions, such as blocks, and generating an encoded bitstream using techniques to limit the information included for respective blocks thereof. The encoded bitstream can be decoded to re-create or reconstruct the source images from the limited information. The information may be limited by lossy coding, lossless coding, or some combination of lossy and lossless coding.

One type of lossless coding is entropy coding, where entropy is generally considered the degree of disorder or randomness in a system. Entropy coding compresses a sequence in an informationally efficient way. That is, a lower bound of the length of the compressed sequence is the entropy of the original sequence. An efficient algorithm for entropy coding desirably generates a code (e.g., in bits) whose length approaches the entropy. For a particular sequence of syntax elements, the entropy associated with the code may be defined as a function of the probability distribution of observations (e.g., symbols, values, outcomes, hypotheses, etc.) for the syntax elements over the sequence. Arithmetic coding can use the probability distribution to construct the code.

However, a codec does not receive a sequence together with the probability distribution. Instead, probability estimation may be used in video codecs to implement entropy coding. That is, the probability distribution of the observations may be estimated using one or more probability estimation models (also called probability or context models herein) that model the distribution occurring in an encoded bitstream so that the estimated probability distribution approaches the actual probability distribution. According to such techniques, entropy coding can reduce the number of bits required to represent the input data to close to a theoretical minimum (i.e., the lower bound).

In practice, the actual reduction in the number of bits required to represent video data can be a function of the accuracy of the context model, the number of bits over which the coding is performed, and the computational accuracy of the (e.g., fixed-point) arithmetic used to perform the coding.

Accuracy is not the only desired goal in entropy coding. The number of symbols representing a single data type is relevant, such as the number of symbols representing a partition type, a transform type, a prediction mode, etc. More symbols result in more complexity. For hardware implementations, for example, complexity can result in the need for a greater die area, a higher cost, a slower speed, etc.

The teachings herein reduce the complexity in entropy coding a partition type for a block in image and video coding. It does this by introducing a bitstream syntax that allows signaling a partition type from a set of available partition types having a defined cardinality, such as ten, using fewer symbols than the defined cardinality, such as seven or eight symbols. In this way, complexity is reduced in entropy coding, hence reducing (e.g., hardware complexity, cost, or both.

Further details of the bitstream syntax for partition types are described herein first with reference to a system in which the teachings may be incorporated.

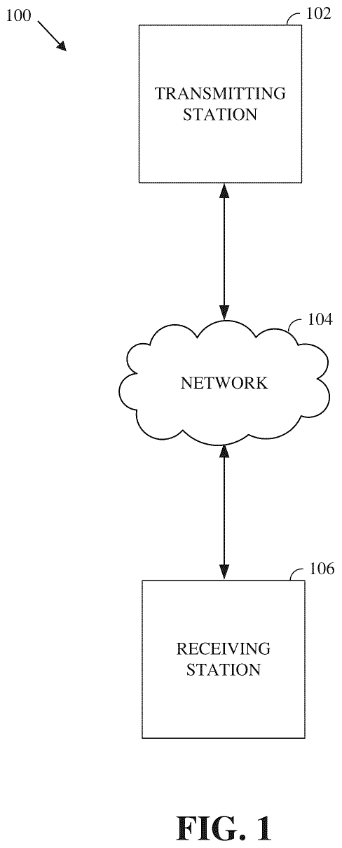

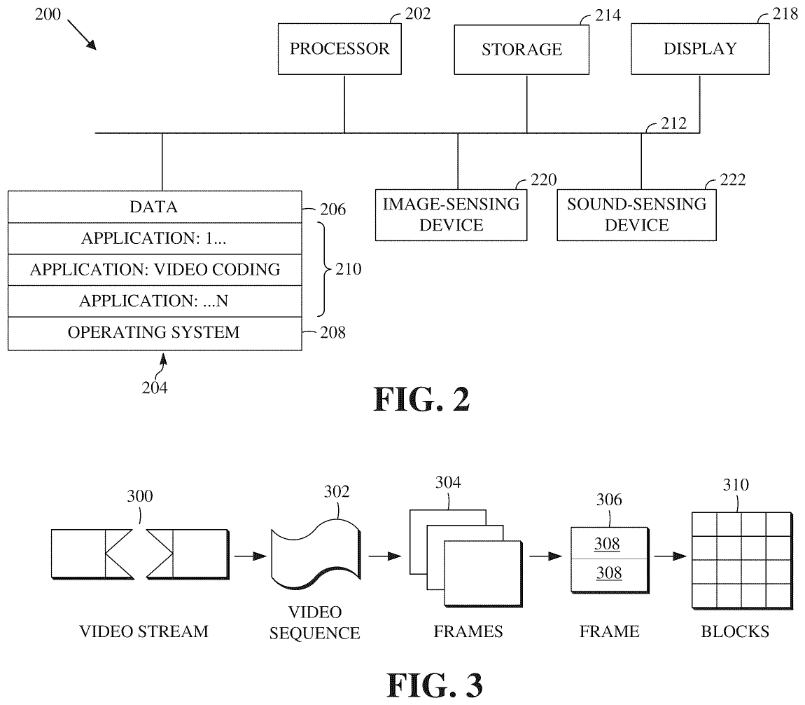

FIG. 1 is a schematic of an example of a video encoding and decoding system 100. A transmitting station 102 can be, for example, a computer having an internal configuration of hardware such as that described in FIG. 2. However, other implementations of the transmitting station 102 are possible. For example, the processing of the transmitting station 102 can be distributed among multiple devices.

A network 104 can connect the transmitting station 102 and a receiving station 106 for encoding and decoding of the video stream. Specifically, the video stream can be encoded in the transmitting station 102, and the encoded video stream can be decoded in the receiving station 106. The network 104 can be, for example, the Internet. The network 104 can also be a local area network (LAN), wide area network (WAN), virtual private network (VPN), cellular telephone network, or any other means of transferring the video stream from the transmitting station 102 to, in this example, the receiving station 106.

The receiving station 106, in one example, can be a computer having an internal configuration of hardware such as that described in FIG. 2. However, other suitable implementations of the receiving station 106 are possible. For example, the processing of the receiving station 106 can be distributed among multiple devices.

Other implementations of the video encoding and decoding system 100 are possible. For example, an implementation can omit the network 104. In another implementation, a video stream can be encoded and then stored for transmission at a later time to the receiving station 106 or any other device having memory. In one implementation, the receiving station 106 receives (e.g., via the network 104, a computer bus, and/or some communication pathway) the encoded video stream and stores the video stream for later decoding. In an example implementation, a real-time transport protocol (RTP) is used for transmission of the encoded video over the network 104. In another implementation, a transport protocol other than RTP may be used, such as a video streaming protocol based on the Hypertext Transfer Protocol (HTTP).

When used in a video conferencing system, for example, the transmitting station 102 and/or the receiving station 106 may include the ability to both encode and decode a video stream as described below. For example, the receiving station 106 could be a video conference participant who receives an encoded video bitstream from a video conference server (e.g., the transmitting station 102) to decode and view and further encodes and transmits his or her own video bitstream to the video conference server for decoding and viewing by other participants.

In some implementations, the video encoding and decoding system 100 may instead be used to encode and decode data other than video data. For example, the video encoding and decoding system 100 can be used to process image data. The image data may include a block of data from an image. In such an implementation, the transmitting station 102 may be used to encode the image data and the receiving station 106 may be used to decode the image data. Alternatively, the receiving station 106 can represent a computing device that stores the encoded image data for later use, such as after receiving the encoded or pre-encoded image data from the transmitting station 102. As a further alternative, the transmitting station 102 can represent a computing device that decodes the image data, such as prior to transmitting the decoded image data to the receiving station 106 for display.

FIG. 2 is a block diagram of an example of a computing device 200 that can implement a transmitting station or a receiving station. For example, the computing device 200 can implement one or both of the transmitting station 102 and the receiving station 106 of FIG. 1. The computing device 200 can be in the form of a computing system including multiple computing devices, or in the form of one computing device, for example, a mobile phone, a tablet computer, a laptop computer, a notebook computer, a desktop computer, and the like.

A processor 202 in the computing device 200 can be a conventional central processing unit. Alternatively, the processor 202 can be another type of device, or multiple devices, capable of manipulating or processing information now existing or hereafter developed. For example, although the disclosed implementations can be practiced with one processor as shown (e.g., the processor 202), advantages in speed and efficiency can be achieved by using more than one processor.

A memory 204 in computing device 200 can be a read only memory (ROM) device or a random-access memory (RAM) device in an implementation. However, other suitable types of storage device can be used as the memory 204. The memory 204 can include code and data 206 that is accessed by the processor 202 using a bus 212. The memory 204 can further include an operating system 208 and application programs 210, the application programs 210 including at least one program that permits the processor 202 to perform the techniques described herein. For example, the application programs 210 can include applications 1 through N, which further include a video coding application that performs the techniques described herein. The computing device 200 can also include a secondary storage 214, which can, for example, be a memory card used with a mobile computing device. Because the video communication sessions may contain a significant amount of information, they can be stored in whole or in part in the secondary storage 214 and loaded into the memory 204 as needed for processing.

The computing device 200 can also include one or more output devices, such as a display 218. The display 218 may be, in one example, a touch sensitive display that combines a display with a touch sensitive element that is operable to sense touch inputs. The display 218 can be coupled to the processor 202 via the bus 212. Other output devices that permit a user to program or otherwise use the computing device 200 can be provided in addition to or as an alternative to the display 218. When the output device is or includes a display, the display can be implemented in various ways, including by a liquid crystal display (LCD), a cathode-ray tube (CRT) display, or a light emitting diode (LED) display, such as an organic LED (OLED) display.

The computing device 200 can also include or be in communication with an image-sensing device 220, for example, a camera, or any other image-sensing device 220 now existing or hereafter developed that can sense an image such as the image of a user operating the computing device 200. The image-sensing device 220 can be positioned such that it is directed toward the user operating the computing device 200. In an example, the position and optical axis of the image-sensing device 220 can be configured such that the field of vision includes an area that is directly adjacent to the display 218 and from which the display 218 is visible.

The computing device 200 can also include or be in communication with a sound-sensing device 222, for example, a microphone, or any other sound-sensing device now existing or hereafter developed that can sense sounds near the computing device 200. The sound-sensing device 222 can be positioned such that it is directed toward the user operating the computing device 200 and can be configured to receive sounds, for example, speech or other utterances, made by the user while the user operates the computing device 200.

Although FIG. 2 depicts the processor 202 and the memory 204 of the computing device 200 as being integrated into a single unit, other configurations can be utilized. The operations of the processor 202 can be distributed across multiple machines (wherein individual machines can have one or more processors) that can be coupled directly or across a local area or other network. The memory 204 can be distributed across multiple machines such as a network-based memory or memory in multiple machines performing the operations of the computing device 200. Although depicted here as one bus, the bus 212 of the computing device 200 can be composed of multiple buses. Further, the secondary storage 214 can be directly coupled to the other components of the computing device 200 or can be accessed via a network and can comprise an integrated unit such as a memory card or multiple units such as multiple memory cards. The computing device 200 can thus be implemented in a wide variety of configurations.

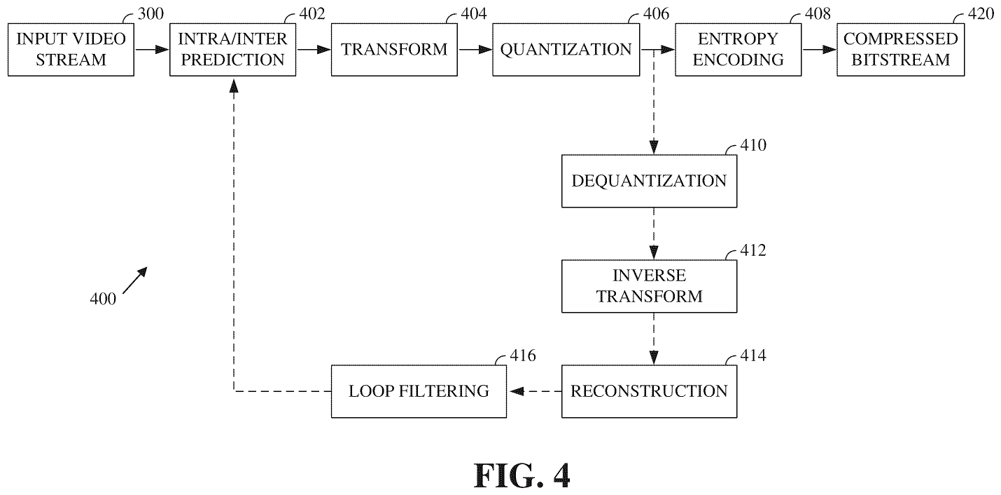

FIG. 3 is a diagram of an example of a video stream 300 to be encoded and subsequently decoded. The video stream 300 includes a video sequence 302. At the next level, the video sequence 302 includes multiple adjacent frames 304. While three frames are depicted as the adjacent frames 304, the video sequence 302 can include any number of adjacent frames 304. The adjacent frames 304 can then be further subdivided into individual frames, for example, a frame 306. At the next level, the frame 306 can be divided into a series of planes or segments 308. The segments 308 can be subsets of frames that permit parallel processing, for example. The segments 308 can also be subsets of frames that can separate the video data into separate colors. For example, a frame 306 of color video data can include a luminance plane and two chrominance planes. The segments 308 may be sampled at different resolutions.

Whether or not the frame 306 is divided into segments 308, the frame 306 may be further subdivided into blocks 310, which can contain data corresponding to, for example, 16×16 pixels in the frame 306. The blocks 310 can also be arranged to include data from one or more segments 308 of pixel data. The blocks 310 can also be of any other suitable size such as 4×4 pixels, 8×8 pixels, 16×8 pixels, 8×16 pixels, 16×16 pixels, or larger. Unless otherwise noted, the terms block and macroblock are used interchangeably herein.

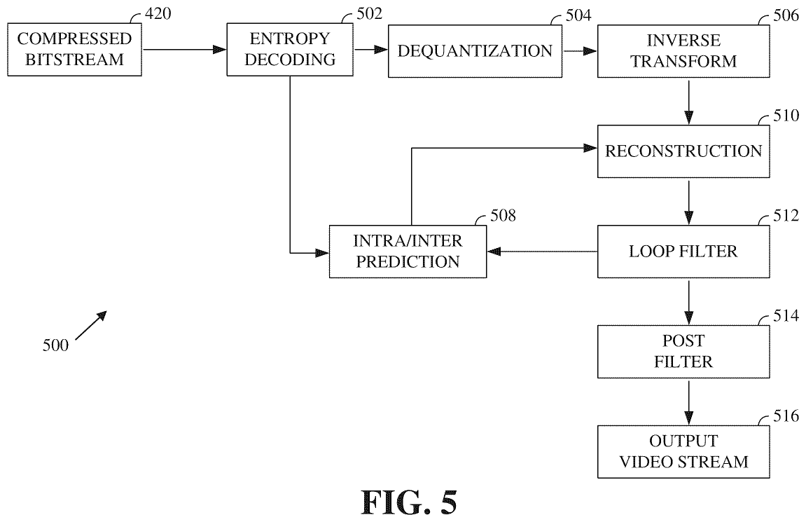

FIG. 4 is a block diagram of an example of an encoder 400. The encoder 400 can be implemented, as described above, in the transmitting station 102, such as by providing a computer software program stored in memory, for example, the memory 204. The computer software program can include machine instructions that, when executed by a processor such as the processor 202, cause the transmitting station 102 to encode video data in the manner described in FIG. 4. The encoder 400 can also be implemented as specialized hardware included in, for example, the transmitting station 102. In one particularly desirable implementation, the encoder 400 is a hardware encoder.

The encoder 400 has the following stages to perform the various functions in a forward path (shown by the solid connection lines) to produce an encoded or compressed bitstream 420 using the video stream 300 as input: an intra/inter prediction stage 402, a transform stage 404, a quantization stage 406, and an entropy encoding stage 408. The encoder 400 may also include a reconstruction path (shown by the dotted connection lines) to reconstruct a frame for encoding of future blocks. In FIG. 4, the encoder 400 has the following stages to perform the various functions in the reconstruction path: a dequantization stage 410, an inverse transform stage 412, a reconstruction stage 414, and a loop filtering stage 416. Other structural variations of the encoder 400 can be used to encode the video stream 300.

When the video stream 300 is presented for encoding, respective adjacent frames 304, such as the frame 306, can be processed in units of blocks. At the intra/inter prediction stage 402, respective blocks can be encoded using intra-frame prediction (also called intra-prediction) or inter-frame prediction (also called inter-prediction). In any case, a prediction block can be formed. In the case of intra-prediction, a prediction block may be formed from samples in the current frame that have been previously encoded and reconstructed. In the case of inter-prediction, a prediction block may be formed from samples in one or more previously constructed reference frames.

Next, the prediction block can be subtracted from the current block at the intra/inter prediction stage 402 to produce a residual block (also called a residual). The transform stage 404 transforms the residual into transform coefficients in, for example, the frequency domain using block-based transforms. The quantization stage 406 converts the transform coefficients into discrete quantum values, which are referred to as quantized transform coefficients, using a quantizer value or a quantization level. For example, the transform coefficients may be divided by the quantizer value and truncated.

The quantized transform coefficients are then entropy encoded by the entropy encoding stage 408. The entropy-encoded coefficients, together with other information used to decode the block (which may include, for example, syntax elements such as used to indicate the type of prediction used, transform type, motion vectors, a quantizer value, or the like), are then output to the compressed bitstream 420. The compressed bitstream 420 can be formatted using various techniques, such as variable length coding (VLC) or arithmetic coding. The compressed bitstream 420 can also be referred to as an encoded video stream or encoded video bitstream, and the terms will be used interchangeably herein.

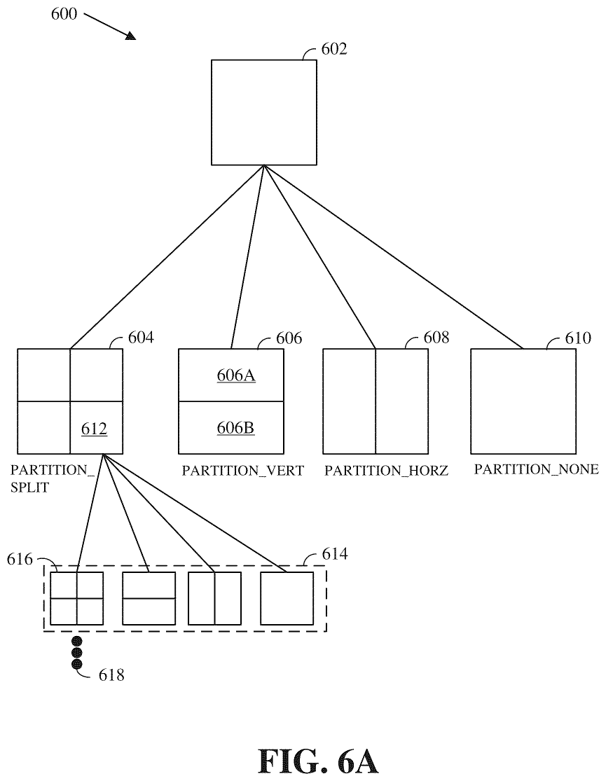

The reconstruction path (shown by the dotted connection lines) can be used to ensure that the encoder 400 and a decoder 500 (described below with respect to FIG. 5) use the same reference frames to decode the compressed bitstream 420. The reconstruction path performs similar functions to functions that take place during the decoding process (described below with respect to FIG. 5), including dequantizing the quantized transform coefficients at the dequantization stage 410 and inverse transforming the dequantized transform coefficients at the inverse transform stage 412 to produce a derivative residual block (also called a derivative residual). At the reconstruction stage 414, the prediction block that was predicted at the intra/inter prediction stage 402 can be added to the derivative residual to create a reconstructed block. The loop filtering stage 416 can be applied to the reconstructed block to reduce distortion such as blocking artifacts.

Other variations of the encoder 400 can be used to encode the compressed bitstream 420. In some implementations, a non-transform based encoder can quantize the residual signal directly without the transform stage 404 for certain blocks or frames. In some implementations, an encoder can have the quantization stage 406 and the dequantization stage 410 combined in a common stage.

FIG. 5 is a block diagram of an example of a decoder 500. The decoder 500 can be implemented in the receiving station 106, for example, by providing a computer software program stored in the memory 204. The computer software program can include machine instructions that, when executed by a processor such as the processor 202, cause the receiving station 106 to decode video data in the manner described in FIG. 5. The decoder 500 can also be implemented in hardware included in, for example, the transmitting station 102 or the receiving station 106.

The decoder 500, like the reconstruction path of the encoder 400 discussed above, includes in one example the following stages to perform various functions to produce an output video stream 516 from the compressed bitstream 420: an entropy decoding stage 502, a dequantization stage 504, an inverse transform stage 506, an intra/inter prediction stage 508, a reconstruction stage 510, a loop filtering stage 512, and a deblocking filtering stage 514. Other structural variations of the decoder 500 can be used to decode the compressed bitstream 420.

When the compressed bitstream 420 is presented for decoding, the data elements within the compressed bitstream 420 can be decoded by the entropy decoding stage 502 to produce a set of quantized transform coefficients. The dequantization stage 504 dequantizes the quantized transform coefficients (e.g., by multiplying the quantized transform coefficients by the quantizer value), and the inverse transform stage 506 inverse transforms the dequantized transform coefficients to produce a derivative residual that can be identical to that created by the inverse transform stage 412 in the encoder 400. Using header information decoded from the compressed bitstream 420, the decoder 500 can use the intra/inter prediction stage 508 to create the same prediction block as was created in the encoder 400 (e.g., at the intra/inter prediction stage 402).

At the reconstruction stage 510, the prediction block can be added to the derivative residual to create a reconstructed block. The loop filtering stage 512 can be applied to the reconstructed block to reduce blocking artifacts. Other filtering can be applied to the reconstructed block. In this example, the deblocking filtering stage 514 is applied to the reconstructed block to reduce blocking distortion, and the result is output as the output video stream 516. The output video stream 516 can also be referred to as a decoded video stream, and the terms will be used interchangeably herein. Other variations of the decoder 500 can be used to decode the compressed bitstream 420. In some implementations, the decoder 500 can produce the output video stream 516 without the deblocking filtering stage 514.

As can be discerned from the description of the encoder 400 and the decoder 500 above, bits are generally used for one of two things in an encoded video bitstream: either content prediction (e.g., inter mode/motion vector coding, intra prediction mode coding, etc.) or residual or coefficient coding (e.g., transform coefficients). Encoders may use techniques to decrease the bits spent on representing this data, including entropy coding. A decoder is informed of (or has available) a context model used to encode an entropy-coded video bitstream so the decoder can decode the video bitstream. Provided an initial state of the probability for each outcome (i.e., each symbol), the codec updates the probability model for each new observation.

For example, an M-ary symbol arithmetic coding method can be used to entropy code syntax elements. In some implementations, integer M∈[2, 16]. An M-ary random variable requires a table of M−1 entries to represent its probability model. The probability mass function (PMF) may be represented as equation (1).

$${\overline{P}}_{n} = [ {p}_{1} ( n ) , {p}_{2} ( n ) , … , {p}_{M} ( n ) ] \qquad ( 1 )$$

The cumulative distribution function (CDF) may be represented as equation (2).

$${\overline{C}}_{n} = [ {c}_{1} ( n ) , {c}_{2} ( n ) , … , {c}_{M - 1} ( n ) , 1 ] , \qquad ( 2 )$$

In each of these equations, n refers to the time variable.

The probability model uses a per symbol update. When a symbol is coded, a new outcome k∈{1, 2, . . . , M} is observed. The probability model is then updated according to equation (3).

$${\overline{P}}_{n} = {\overline{P}}_{n - 1} ( 1 - α ) + α {\overline{e}}_{k} , \qquad ( 3 )$$

In equation (3), ēₖ is an indicator vector whose k-th element is 1 and the rest are 0, and α is the update rate. This translates into an equivalent CDF update equation (4).

$${c}_{m} ( n ) = \{ \begin{matrix}{c}_{m} ( n - 1 ) \cdot ( 1 - α ) , m < k \\ {c}_{m} ( n - 1 ) + α \cdot ( 1 - {c}_{m} ( n - 1 ) ) , m \geq k\end{matrix} \qquad ( 4 )$$

The update rate is defined by equation (5), where count is the number of symbols coded at the time of the update.

$$α = \frac{1}{{2}^{3 + I ( count > 15 ) + I ( count > 31 ) + m i n ( lo {g}_{2} ( M ) , 2 )}} \qquad ( 5 )$$

Reducing complexity in entropy coding can be achieved by reducing the maximum supported symbol size. Instead of M∈[2, 16], for example, M∈[2, 8] would significantly reduce complexity. However, this is difficult to achieve when the number of choices for a syntax element is greater than 8.

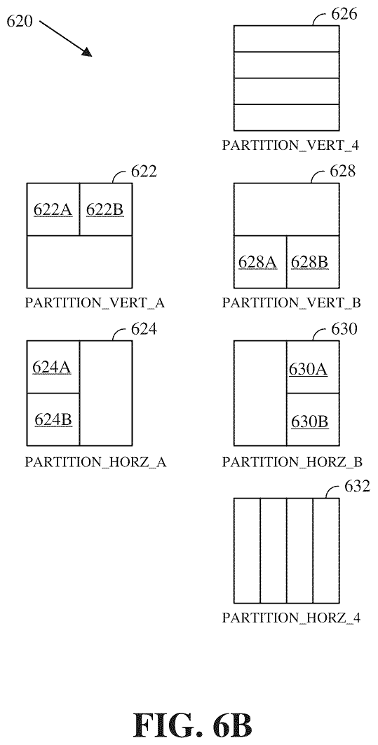

For example, the number of symbols used to represent the syntax element partition type for a block of an image or frame may be equal to the number of partition types. This may be explained with reference to FIG. 6A, which is a block diagram of an example 600 of recursive partitioning of a block, and FIG. 6B, which is a block diagram of an example 620 of extended partition types of a block. In these examples, the block is a coding block partitioned into prediction blocks, but the principles described herein equally apply to other block partitioning, such as partitioning into transform blocks.

The example 600 includes a coding block 602. Inter prediction or intra prediction is performed with respect to the coding block 602. That is, the coding block 602 can be partitioned (e.g., divided, split, or otherwise partitioned) into one or more prediction units (PU) or blocks (or sub-blocks) according to a partition type, such as one of the partition types described herein. Each PU can be predicted using inter prediction or intra prediction. In an example, the process described with respect to the example 600 can be performed (e.g., implemented) by an intra/inter-prediction stage, such as the intra/inter-prediction stage 402 of the encoder 400 of FIG. 4. It is noted while certain partitions are described with respect to FIGS. 8A and 8B, these partitions are meant to be illustrative and non-limiting. Other partition types are possible.

The coding block 602 can be a chrominance block. The coding block 602 can be a luminance block. In an example, a partition is determined for a luminance block, and a corresponding chrominance block uses the same partition as that of the luminance block. In another example, a partition of a chrominance block can be determined independently of the partition of a luminance block.

The example 600 illustrates a recursive partition search (performed at an encoder) of the coding block 602. The recursive search is performed to determine the partition that results in the optimal rate-distortion (RD) cost. An RD cost can include the cost of encoding both the luminance and the chrominance blocks corresponding to a block.

The example 600 illustrates four partition types that may be available at an encoder. A partition type 604 (also referred to herein as the PARTITION_SPLIT partition type and partition-split partition type) splits the coding block 602 into four equally sized square sub-blocks. For example, if the coding block 602 is of size N×N, then each of the four sub-blocks of the PARTITION_SPLIT partition type is of size N/4×N/4. Each of the four sub-blocks resulting from the partition type 604 may or may not itself correspond to a prediction unit/block, as it may be further partitioned as described below.

A partition type 606 (also referred to herein as the PARTITION_VERT partition type) splits the coding block 602 into two adjacent rectangular prediction units, each of size N×N/2. A partition type 608 (also referred to herein as the PARTITION_HORZ partition type) splits the coding block 602 into two adjacent rectangular prediction units, each of size N/2×N. A partition type 610 (also referred to herein as the PARTITION_NONE partition type and partition-none partition type) uses one prediction unit for the coding block 602 such that the prediction unit has the same size (i.e., N×N) as the coding block 602.

For brevity, a partition type may simply be referred to herein by its name only. For example, instead of using “the PARTITION_VERT partition type,” “the PARTITION_VERT” may be used instead. As another example, instead of “the partition-none partition type,” “the partition-none” may be used. Additionally, uppercase or lowercase letters may be used to refer to partition type names. As such, “PARTITION_VERT” and “partition-vert” refer to the same partition type.

Except for the partition type 604, none of the other partitions can be split further. As such, the partition types 606-610 can be considered end points. Each of the sub-blocks of a partition (according to a partition type) that is not an end point can be further partitioned using the available partition types. As such, partitioning can be further performed for square coding blocks. The sub-blocks of a partition type that is an end point are not partitioned further. As such, further partitioning is possible only for the sub-blocks of the PARTITION_SPLIT partition type.

As mentioned above, to determine the minimal RD cost for the coding block 602, the coding block is partitioned according to the available partition types, and a respective cost (e.g., an RD cost) of encoding the block based on each partition is determined. The partition type resulting in the smallest RD cost is selected as the partition type to be used for partitioning and encoding the coding block.

The RD cost of a partition is the sum of the RD costs of each of the sub-blocks of the partition. For example, the RD cost associated with the PARTITION_VERT (i.e., the partition type 606) is the sum of the RD cost of a sub-block 606A and the RD cost of a sub-block 606B. The sub-blocks 606A and 606B are prediction units.

To determine an RD cost associated with a prediction block, an encoder can predict the prediction block using at least some of the available prediction modes (i.e., available inter- and intra-prediction modes). In an example, for each of the prediction modes, a corresponding residual is determined, transformed, and quantized to determine the distortion and the rate (in bits) associated with the prediction mode. As mentioned, the partition type resulting in the smallest RD cost can be selected. Selecting a partition type can mean, inter alia, encoding in a compressed bitstream, such as the compressed bitstream 420 of FIG. 4, the partition type. Encoding the partition type can mean encoding an identifier corresponding to the partition type. Encoding the identifier corresponding to the partition type can mean entropy encoding, such as by the entropy encoding stage 408 of FIG. 4, the identifier.

To determine the RD cost corresponding to the PARTITION_SPLIT (i.e., the partition type 604), a respective RD cost corresponding to each of the sub-blocks, such as a sub-block 612, is determined. As the sub-block 612 is a square sub-block, the sub-block 612 is further partitioned according to the available partition types to determine a minimal RD cost for the sub-block 612. The sub-block 612 is thus further partitioned as shown with respect to partitions 614. As the sub-blocks of a partition 616 (corresponding to the PARTITION_SPLIT) are square sub-blocks, the process repeats for each of the sub-blocks of the partition 616, as illustrated with an ellipsis 618, until each of a smallest square sub-block size is reached. The smallest square sub-block size corresponds to a block size that is not partitionable further. In an example, the smallest square sub-block size, for a luminance block, is a 4×4 block size.

As mentioned above, more partition types than those described with respect to FIG. 6A can be available at a codec. The example 820 of FIG. 6B shows extended partition types of a block. The term “extended” in this context can mean “additional.”

A partition type 622 (also referred to herein as the PARTITION_VERT_A) splits an N×N coding block into two horizontally adjacent square blocks, each of size N/2×N/2, and a rectangular prediction unit of size N×N/2. A partition type 628 (also referred to herein as the PARTITION_VERT_B) splits an N×N coding block into a rectangular prediction unit of size N×N/2 and two horizontally adjacent square blocks, each of size N/2×N/2.

A partition type 624 (also referred to herein as the PARTITION_HORZ_A) splits an N×N coding block into two vertically adjacent square blocks, each of size N/2×N/2, and a rectangular prediction unit of size N/2×N. A partition type 630 (also referred to herein as the PARTITION_HORZ_B) splits an N×N coding block into a rectangular prediction unit of size N/2×N and two vertically adjacent square blocks, each of size N/2×N/2.

A partition type 626 (also referred to herein as the PARTITION_VERT_4) splits an NXN coding block into four vertically adjacent rectangular blocks, each of size N×N/4. A partition type 632 (also referred to herein as the PARTITION_HORZ_4) splits an N×N coding block into four horizontally adjacent rectangular blocks, each of size N/4×N.

As mentioned above, a recursive partition search (e.g., based on a quad-tree partitioning) can be applied to square sub-blocks, such as sub-blocks 622A, 622B, 624A, 624B, 628A, 628B, 630A, and 630B.

The cardinality of available or possible partition types in this example is 10, which may be associated with the identifiers in Table 1.

TABLE 1

| Partition | Partition name/type |
|---|---|
| 0 | PARTITION_NONE |
| 1 | PARTITION_HORZ |
| 2 | PARTITION_VERT |
| 3 | PARTITION_SPLIT |
| 4 | PARTITION_HORZ_A |
| 5 | PARTITION_HORZ_B |
| 6 | PARTITION_VERT_A |
| 7 | PARTITION_VERT_B |
| 8 | PARTITION_HORZ_4 |
| 9 | PARTITION_VERT_4 |

Each block may be assigned a unique partition type, which is entropy encoded at the encoder and explicitly signaled in the bitstream to a decoder. Using the multi-symbol arithmetic coding described above as an example, the single variable “partition identifier” The partition type, such as for a respective block, may be signaled in the bit stream using a variable, such as one variable, to represent the partition type, having a cardinality (or number) of values corresponding to the number of available partition types, such as ten values. Accordingly, in the arithmetic (entropy) coding, a probability table with ten, for example, symbols (entries) is used to calculate the probability update of the variable. However, signaling one value using ten symbols may increase complexity and cost (die area, cost, speed, etc.) for hardware implementations. Accordingly, reducing the number of symbols used to fewer than the number of available partition types can be advantageous.

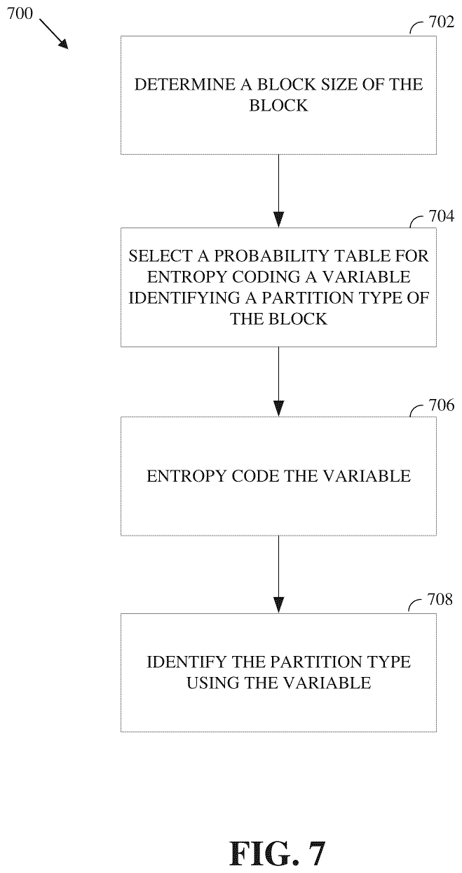

Reducing the number of symbols may be achieved by using a larger number of variables, each associated with a probability table. The separate probability tables allow the cardinality of symbols used for entropy coding to be reduced below the cardinality of the available partition types. To do this, a bitstream syntax change for partition types as compared to that described above is required. The bitstream syntax is explained below with reference to FIG. 7.

FIG. 7 is a flowchart diagram of a technique or process 700 of decoding a partition type of a block. The process 700 can be implemented, for example, as a software program that may be executed by computing devices such as the transmitting station 102 or the receiving station 106. The software program can include machine-readable instructions that may be stored in a memory such as the memory 204 or the secondary storage 214, and that, when executed by a processor, such as the processor 202, may cause the computing device to perform the process 700. The process 700 may be implemented in one or more stages of a decoder, such as the entropy decoding stage 502 of the decoder 500. The process 700 can be implemented using specialized hardware or firmware. Multiple processors, memories, or both, may be used. The process 700 may be repeated for blocks of an image, such as a still image or images that correspond to frames of a video sequence.

While the process illustrates a process 700 of decoding a partition type of a block, a similar process is used for encoding a partition type of a block. Accordingly, the process for encoding will be described in conjunction with the process 700. For the encoder, the partition type is known and hence is written into the bitstream. For the decoder, the bitstream is read to derive (identify, determine, etc.) the partition type.

The process for encoding can be implemented, for example, as a software program that may be executed by computing devices such as the transmitting station 102. The software program can include machine-readable instructions that may be stored in a memory such as the memory 204 or the secondary storage 214, and that, when executed by a processor, such as the processor 202, may cause the computing device to perform the process. The process may be implemented in one or more stages of an encoder, such as the entropy encoding stage 408 of the encoder 400. The process can be implemented using specialized hardware or firmware. Multiple processors, memories, or both, may be used. The process may be repeated for blocks of an image, such as a still image or images that correspond to frames of a video sequence.

At operation 702, a block size of the block is determined. The block may be a square block, such as a coding block having a size of 128×128 pixels as described above with regards to FIG. 6A. The block may be a smaller block that results from partitioning a larger block. At an encoder, the size of the block may be determined by the recursive partitioning described above with regards to FIGS. 6A and 6B. At a decoder, the size of the block may be determined from information encoded within an encoded bitstream, such as the compressed bitstream 420. The information can include or be derived from the block position relative to a coding unit within the bitstream and the partition types of previously decoded blocks. Other ways of determining the block size at a decoder from the bitstream information are possible. The block position within the image is represented by the coordinate (x, y) of the top-left corner of the block, and a block size may be specified by a width w and a height h.

At operation 704, a probability table is selected for entropy coding a variable identifying a partition type of the block. The selection of the probability table uses the block size. This same operation is performed at an encoder, but the encoder includes an additional operation of determining the variable identifying the partition type. Determining the variable at the encoder is next described with reference to the example of FIGS. 6A and 6B and Table 1.

In some implementations, the partition type may be represented using a defined cardinality of variables, such as seven variables, corresponding to a defined cardinality of probability tables, such as seven probability tables.

For example, the probability tables may include the following tables wherein the last (right most) dimension of the respective table corresponds with the cardinality of symbols used for signaling. The other dimensions are contexts. Possible context information may include the block type, the prediction mode, the block position, etc., or other variables relevant to the coding of the block.
partition_8×8_table[2][4][4]
partition_128×128_table[2][4][8]
partition_class_table[2][12][2]
a partition_offset_1_table[2][12][4]
a partition_offset_2_table[2][12][6]
partition_horz_boundary_table[2][12][2]
partition_vert_boundary_table[2][12][2].

In addition to the variable of the size of the block (e.g., the width w and height h), and the variable of the coordinate (x, y) identifying the block position within the image, the variable of the size of the image may be used. This variable may be represented by Frame Width, which represents the width of the image, and FrameHeight, which represents the height of the image. In some implementations, these variables (e.g., represented by x, y, w, h, FrameWidth, and FrameHeight) may be expressed in units of four (4).

The encoder knows the partition type from the cardinality of available for partition types as described above. For example, a value of the variable P can represent the value of the partition type, such a value between 0 and 9 according to Table 1. To reduce the cardinality of symbols for entropy coding, one or more additional variables to represent the partition are determined that allows for context reduction.

C is a variable that has a first value or a second value based on the value of P. For example, when P is greater than a threshold, such as three (P>3), C has the first value, such as one (C=1). Then, if P is less than or equal to the threshold, C has the second value, such as zero (C=0). D is a variable that has a first value of a second value based on the value of P. For example, when P is equal to the threshold, D has the first value, such as one (D=1), and otherwise D has the second value, such as zero (C=0). E is a variable corresponding to an offset as described below. Note that these variables and thresholds are used because the example described herein has 10 available partitions, and it is desired to transmit a variable that can be entropy coded using no more than 8 symbols. Additional and/or other variables and thresholds may be used.

If the block size is the smallest block size that can still be partitioned, the variable is determined as P. Then, selecting the probability table for entropy coding the variable P, which identifies the partition type is selected as a first probability table of the multiple available probability tables. In this example, the block size is 8×8 pixels, and the probability table is partition_8×8_table.

If the block size is not the smallest block size as described above, then the encoder can determine whether the block size is the coding unit size. In this case also, the variable is determined as P. Then, selecting the probability table for entropy coding the variable P, which identifies the partition type is selected as a second probability table of the multiple available probability tables. In this example, the block size is 128×128 pixels, and the probability table is partition_128×128_table.

If the block size is neither of these sizes, then the variable is not the variable P. Instead, the variable to be entropy coded is determined by a further sequence of queries. For example, the block size may be 16×16 pixels, 32×32 pixels, or 64×64 pixels.

The sequence of queries starts with comparing the position of the block with one or more boundaries of the image. For example, if (x+w/2<Frame Width) and (y+h/2>=FrameHeight), the variable is D. Then, selecting the probability table for entropy coding the variable D, which identifies the partition type is selected as a third probability table of the multiple available probability tables. In this example, the probability table is partition_horz_boundary_table.

If these conditions are not satisfied, the next query is whether (x+w/2>=Frame Width) and (y+h/2<FrameHeight). In this case, the variable is D. Then, selecting the probability table for entropy coding the variable D, which identifies the partition type is selected as a fourth probability table of the multiple available probability tables. In this example, the probability table is partition_vert_boundary_table.

If neither set of conditions is met, the variable is C. Then, selecting the probability table for entropy coding the variable C, which identifies the partition type is selected as a fifth probability table of the multiple available probability tables. In this example, the probability table is partition_class_table. When the variable C is used to identify the partition type, and the variable E (an offset value) is also determined and encoded into the bitstream to be used with the variable C to encode the partition type.

When C is zero (C=0), the value of the variable E is equal to P. The sixth probability table partition_offset_1_table is used for entropy coding E. Otherwise the value of the variable E is P−4. The seventh probability table partition_offset_2_table is used for entropy coding E.

Selecting a probability table at a decoder at operation 704, a probability table is selected for entropy coding a variable identifying a partition type of the block. The selection of the probability table is performed according to the same sequence as the encoder.

At operation 706, the variable is entropy coded using a cardinality of symbols associated with the probability table, wherein the cardinality of symbols is less than a cardinality of available partition types. The entropy coding may be completed as described above to read P, D, C, and/or E from the bitstream.

At operation 708, the partition type is determined or identified using the variable or combination of variables.

The techniques described herein describe a bitstream syntax for partition types. Using the techniques, complexity of entropy coding partition types can be reduced by reducing the number of symbols (e.g., from 10 to 8) without noticeable compression efficiency loss. The techniques increase the number of variables while increasing the number of probability tables. This can reduce the cost of a hardware implementation, for example.

For simplicity of explanation, the techniques herein may be depicted and described as a series of blocks, steps, or operations. However, the blocks, steps, or operations in accordance with this disclosure can occur in various orders and/or concurrently. Additionally, other steps or operations not presented and described herein may be used. Furthermore, not all illustrated steps or operations may be required to implement a technique in accordance with the disclosed subject matter.

The aspects of encoding and decoding described above illustrate some examples of encoding and decoding techniques. However, it is to be understood that encoding and decoding, as those terms are used in the claims, could mean compression, decompression, transformation, or any other processing or change of data.

The word “example” is used herein to mean serving as an example, instance, or illustration. Any aspect or design described herein as “example” is not necessarily to be construed as being preferred or advantageous over other aspects or designs. Rather, use of the word “example” is intended to present concepts in a concrete fashion. As used in this application, the term “or” is intended to mean an inclusive “or” rather than an exclusive “or.” That is, unless specified otherwise or clearly indicated otherwise by the context, the statement “X includes A or B” is intended to mean any of the natural inclusive permutations thereof. That is, if X includes A; X includes B; or X includes both A and B, then “X includes A or B” is satisfied under any of the foregoing instances. In addition, the articles “a” and “an” as used in this application and the appended claims should generally be construed to mean “one or more,” unless specified otherwise or clearly indicated by the context to be directed to a singular form. Moreover, use of the term “an implementation” or the term “one implementation” throughout this disclosure is not intended to mean the same implementation unless described as such.

Implementations of the transmitting station 102 and/or the receiving station 106 (and the algorithms, methods, instructions, etc., stored thereon and/or executed thereby, including by the encoder 400 and the decoder 500) can be realized in hardware, software, or any combination thereof. The hardware can include, for example, computers, intellectual property (IP) cores, application-specific integrated circuits (ASICs), programmable logic arrays, optical processors, programmable logic controllers, microcode, microcontrollers, servers, microprocessors, digital signal processors, or any other suitable circuit. In the claims, the term “processor” should be understood as encompassing any of the foregoing hardware, either singly or in combination. The terms “signal” and “data” are used interchangeably. Further, portions of the transmitting station 102 and the receiving station 106 do not necessarily have to be implemented in the same manner.

Further, in one aspect, for example, the transmitting station 102 or the receiving station 106 can be implemented using a general-purpose computer or general-purpose processor with a computer program that, when executed, carries out any of the respective methods, algorithms, and/or instructions described herein. In addition, or alternatively, for example, a special purpose computer/processor can be utilized which can contain other hardware for carrying out any of the methods, algorithms, or instructions described herein.

The transmitting station 102 and the receiving station 106 can, for example, be implemented on computers in a video conferencing system. Alternatively, the transmitting station 102 can be implemented on a server, and the receiving station 106 can be implemented on a device separate from the server, such as a handheld communications device. In this instance, the transmitting station 102, using an encoder 400, can encode content into an encoded video signal and transmit the encoded video signal to the communications device. In turn, the communications device can then decode the encoded video signal using a decoder 500. Alternatively, the communications device can decode content stored locally on the communications device, for example, content that was not transmitted by the transmitting station 102. Other suitable transmitting and receiving implementation schemes are available. For example, the receiving station 106 can be a generally stationary personal computer rather than a portable communications device, and/or a device including an encoder 400 may also include a decoder 500.

Further, all or a portion of implementations of this disclosure can take the form of a computer program product accessible from, for example, a computer-usable or computer-readable medium. A computer-usable or computer-readable medium can be any device that can, for example, tangibly contain, store, communicate, or transport the program for use by or in connection with any processor. The medium can be, for example, an electronic, magnetic, optical, electromagnetic, or semiconductor device. Other suitable mediums are also available.

The above-described implementations and other aspects have been described to facilitate easy understanding of this disclosure and do not limit this disclosure. On the contrary, this disclosure is intended to cover various modifications and equivalent arrangements included within the scope of the appended claims, which scope is to be accorded the broadest interpretation as is permitted under the law to encompass all such modifications and equivalent arrangements.

1. A method of decoding, comprising:
determining a block size of a block;
selecting, based on the block size, a probability table for entropy coding a variable identifying a partition type for the block, wherein the probability table is selected from multiple available probability tables;
entropy coding the variable using a cardinality of symbols associated with the probability table, wherein the cardinality of symbols is less than a cardinality of available partition types; and
determining the partition type using the variable.

2. The method of claim 1, wherein selecting the probability table comprises selecting the probability table based on the block size and a position of the block relative to at least one boundary of an image containing the block.

3. The method of claim 2, wherein selecting the probability table comprises selecting the probability table based on the block size and a position of the block relative to each of a vertical boundary and a horizontal boundary of the image.

4. A method of encoding, comprising:
determining a block size of a block;
determining a variable identifying a partition type for the block;
selecting, based on the block size, a probability table for entropy coding the variable identifying the partition type, wherein the probability table is selected from multiple available probability tables; and
entropy coding the variable using a cardinality of symbols associated with the probability table, wherein the cardinality of symbols is less than a cardinality of available partition types.

5. The method of claim 4, wherein selecting the probability table comprises selecting the probability table based on the block size and a position of the block relative to at least one boundary of an image containing the block.

6. The method of claim 4, wherein selecting the probability table comprises selecting the probability table based on the block size and a position of the block relative to each of a vertical boundary and a horizontal boundary of an image containing the block.

7. An apparatus for encoding comprising a processor configured to perform the method of claim 4.

8. The apparatus of claim 7, wherein the apparatus is a hardware encoder.

9. The apparatus of claim 7, wherein the processor is configured to encode each sub-block of the block indicated by the partition type according to a respective prediction mode.

10. The method of claim 1, comprising:
decoding each sub-block of the block indicated by the partition type according to a respective prediction mode.

11. An apparatus for decoding, comprising:
a processor configured to:
determine a block size of a block;
select, based on the block size, a probability table for entropy coding a variable identifying a partition type for the block, wherein the probability table is selected from multiple available probability tables;
entropy code the variable using a cardinality of symbols associated with the probability table, wherein the cardinality of symbols is less than a cardinality of available partition types; and
determine the partition type using the variable.

12. The apparatus of claim 11, wherein to select the probability table comprises to select the probability table based on the block size and a position of the block relative to at least one boundary of an image containing the block.

13. The method of claim 11, wherein to select the probability table comprises to select the probability table based on the block size and a position of the block relative to each of a vertical boundary and a horizontal boundary of the image.

14. The apparatus of claim 11, wherein the processor is configured to decode each sub-block of the block indicated by the partition type according to a respective prediction mode.

15. The apparatus of claim 11, wherein the apparatus comprises a hardware decoder.

16. The apparatus of claim 11, wherein the cardinality of available partition types is 10.
